(19) United States
(12) Patent Application Publication
(10) Pub. No.: US 2024/0329628 A1
(43) Pub. Date: Oct. 3, 2024

(54) REAL-TIME SAMPLE ASPIRATION FAULT DETECTION AND CONTROL

(71) Applicant: Siemens Healthcare Diagnostics Inc., Tarrytown, NY (US)

(72) Inventor: Narayanan Ramakrishnan, New City, NY (US)

(73) Assignee: Siemens Healthcare Diagnostics Inc., Tarrytown, NY (US)

(21) Appl. No.: 18/579,318

(22) PCT Filed: Jul. 12, 2022
(86) PCT No.: PCT/US2022/073655

§ 371 Date: Jan. 12, 2024

Related U.S. Application Data
(60) Provisional application No. 63/221,450, filed on Jul. 13, 2021.

(51) Int. Cl. G05B 23/02; G01N 35/10

(52) U.S. Cl. CPC G05B 23/024; G01N 35/1016; G05B 23/0281

(57) ABSTRACT

Methods of early real-time detection or prediction of aspiration faults in an automated diagnostic analysis system include an artificial intelligence algorithm configured to use either cluster analysis or probabilistic graphical modeling based on an aspiration pressure measurement signal waveform. Aspiration faults may include short-volume aspiration and unwanted gel pick-up. These methods may allow for timely termination of an aspiration process so as to avoid or minimize possible detrimental downstream consequences such as faulty sample test results and/or instrument downtime for servicing and cleanup. Apparatus for early real-time detection or prediction of aspiration faults are provided as are other aspects.

### CROSS REFERENCE TO RELATED APPLICATION

This application claims the benefit of U.S. Provisional Patent Application No. 63/221,450, entitled “REAL-TIME SAMPLE ASPIRATION FAULT DETECTION AND CONTROL” filed Jul. 13, 2021, the disclosure of which is hereby incorporated by reference in its entirety for all purposes.

### FIELD

This disclosure relates to aspiration of liquids in automated diagnostic analysis systems.

### BACKGROUND

In medical testing, automated diagnostic analysis systems may be used to analyze a biological sample to identify an analyte or other constituent in the sample. The biological sample may be, e.g., urine, whole blood, blood serum, blood plasma, interstitial liquid, cerebrospinal liquid, and the like. Such biological liquid samples are usually contained in sample containers (e.g., test tubes, vials, etc.) and may be transported via container carriers and automated tracks to and from various imaging, processing, and analyzer stations within an automated diagnostic analysis system.

Automated diagnostic analysis systems typically include one or more automated aspirating and dispensing apparatus, which are configured to aspirate (draw in) a liquid (e.g., a sample of a biological liquid or a liquid reagent, acid, or base to be mixed with the sample) from a liquid container and dispense the liquid into a reaction vessel (e.g., a cuvette or the like). The aspirating and dispensing apparatus typically includes a probe (e.g., a pipette) mounted on a moveable robotic arm or other automated mechanism that performs the aspiration and dispensing functions and transfers the sample or reagent to the reaction vessel.

During the aspiration process, the moveable robotic arm, which may be controlled by a system controller or processor, may position the probe above a liquid container and then lower the probe into the container until the probe is partially immersed in the liquid (e.g., a biological liquid sample or liquid reagent). A pump or other aspirating device is then activated to aspirate (draw in) a portion of the liquid from the container into the interior of the probe. The probe is then withdrawn from the container and moved such that the liquid may be transferred to and dispensed into a reaction vessel for processing and/or analysis.

During or after the aspiration, an aspiration pressure signal may be analyzed to determine whether any anomalies occurred, i.e., check for the presence of a clog (e.g., pickup of a gel or other undesirable material from the liquid container) or an insufficient amount of aspirated liquid (which may be referred to hereinafter as a short-volume aspiration or fault).

While conventional aspiration detection systems may be able to detect some abnormal aspirations, such conventional detection may not sufficient to avoid some detrimental consequences. Accordingly, there is a need for improved methods and apparatus for detection and/or prediction of an aspiration fault so as to avoid or minimize such possible detrimental consequences.

### SUMMARY

In some embodiments, a method of detecting or predicting an aspiration fault in an automated diagnostic analysis system is provided. The method includes performing aspiration pressure measurements via a pressure sensor as a liquid is being aspirated in the automated diagnostic analysis system. The method also includes analyzing an aspiration pressure measurement signal waveform via a processor executing an artificial intelligence (AI) algorithm. The AI algorithm is configured to perform either cluster analysis of the aspiration pressure measurement signal waveform or probabilistic graphical modeling based on the aspiration pressure measurement signal waveform. The method further includes identifying and responding to an aspiration fault via the processor in response to the analyzing.

In some embodiments, an automated aspirating and dispensing apparatus is provided that includes a robotic arm, a probe coupled to the robotic arm, a pump coupled to the probe, a pressure sensor configured to perform aspiration pressure measurements as a liquid is being aspirated via the probe, and a processor configured to execute an artificial intelligence (AI) algorithm to detect or predict and respond to an aspiration fault during an aspiration process. The AI algorithm is configured to analyze an aspiration pressure measurement signal waveform derived from the pressure sensor using cluster analysis or probabilistic graphical modeling.

In some embodiments, a non-transitory computer-readable storage medium includes an artificial intelligence (AI) algorithm configured to detect or predict an aspiration fault based on analysis of an aspiration pressure measurement signal waveform. The analysis may be a cluster analysis of the aspiration pressure measurement signal waveform or may use probabilistic graphical modeling based on the aspiration pressure measurement signal waveform.

Still other aspects, features, and advantages of this disclosure may be readily apparent from the following detailed description and illustration of a number of example embodiments and implementations, including the best mode contemplated for carrying out the invention. This disclosure may also be capable of other and different embodiments, and its several details may be modified in various respects, all without departing from the scope of the invention. For example, although the description below relates to automated diagnostic analysis systems, the aspiration fault detection and/or prediction methods and apparatus disclosed herein may be readily adapted to other automated systems that would benefit from early and accurate real-time detection and/or prediction of aspiration faults. This disclosure is intended to cover all modifications, equivalents, and alternatives falling within the scope of the claims.

### BRIEF DESCRIPTION OF DRAWINGS

The drawings, described below, are for illustrative purposes, and are not necessarily drawn to scale. Accordingly, the drawings and descriptions are to be regarded as illustrative in nature, and not as restrictive. The drawings are not intended to limit the scope of the invention in any way.

FIG. 1 illustrates a top schematic view of an automated diagnostic analysis system configured to analyze biological samples according to embodiments provided herein.

FIGS. 2A and 2B each illustrate a front view of a sample container according to embodiments provided herein.

FIG. 3 illustrates a front schematic view of aspirating and dispensing apparatus according to embodiments provided herein.

FIG. 4 illustrates a flowchart of a method of detecting or predicting an aspiration fault in an automated diagnostic analysis system according to embodiments provided herein.

FIG. 5 illustrates a graph of a plurality of pressure signal waveforms representing normal aspiration according to embodiments provided herein.

FIG. 6 illustrates a graph of a plurality of pressure signal waveforms representing abnormal aspiration according to embodiments provided herein.

FIG. 7 illustrates a graph of normal aspiration pressure signal waveforms and a selected constant offset value P (threshold) according to embodiments provided herein.

FIG. 8 illustrates a flowchart of a method of training an AI algorithm for clustering-based analysis of aspiration pressure signal waveforms according to embodiments provided herein.

FIGS. 9 and 10 each illustrate a graph of a plurality of pressure signal waveforms representing normal and abnormal aspiration and respective upper and lower thresholds based on global minimum and maximum values of respective metrics used to predict aspiration faults.

FIGS. 11 and 12 each illustrates graphs of a four-cluster classification based on a respective metric according to embodiments provided herein.

FIGS. 13 and 14 each illustrate a graph of a baseline classification range for a respective metric according to embodiments provided herein.

FIGS. 15A and 15B illustrate graphs of a two-cluster per metric classification of aspiration pressure signal waveforms according to embodiments provided herein.

FIG. 16 illustrates architecture of a Hidden Markov Model for analyzing aspiration pressure signal waveforms according to embodiments provided herein.

FIG. 17 illustrates a histogram of detected aspiration faults showing most faults detected within the first 100 msec of an aspiration process according to embodiments provided herein.

### DETAILED DESCRIPTION

Some conventional systems may be able to detect some abnormal aspirations, but such detection may not occur early enough in the aspiration process to avoid possible detrimental downstream consequences, such as, e.g., inaccurate testing results because of a short-volume aspiration and/or instrument downtime for servicing and cleanup of a probe and other affected mechanisms and subsystems because of a gel or other undesirable material pickup.

Thus, embodiments described herein provide methods and apparatus to accurately detect or predict, in real-time, an aspiration fault early in the aspiration process. Early real-time aspiration fault detection or prediction may allow the aspiration process to be timely terminated and/or a suitable error state procedure to be implemented so as to advantageously avoid or minimize any possible downstream consequences of a faulty aspiration, such as, e.g., instrument downtime and/or erroneous analysis results. In some embodiments, an aspiration fault may be advantageously detected or predicted within the first 100 msec of starting an aspiration process. Detectable and/or predictable aspiration faults may include a gel (or other undesirable material) pickup fault and/or a short-volume fault, for example. A short-volume fault occurs when an aspiration fails to draw in a sufficient volume of liquid, which may be caused by, e.g., a liquid container with an insufficient volume of liquid and/or defective equipment (e.g., a defective aspiration pump or aspiration tube, a defective robotic arm improperly positioning a probe within a liquid container, a blockage, etc.). A gel pickup fault may also be caused by defective equipment (e.g., a defective robotic arm improperly positioning a probe within a liquid container such that the probe comes into contact with or is too close to a gel separator between sample components in a liquid container or to a bottom layer of gel or red blood cells in the liquid container wherein the gel is consequently aspirated into the probe).

In some embodiments, early and accurate real-time detection or prediction of aspiration faults may be implemented via a software or firmware learning-based AI (artificial intelligence) algorithm executing on a system controller, processor, or other like computer device of an automated diagnostic analysis system or an automated aspirating and dispensing apparatus. In some embodiments, the AI algorithm may be configured to perform a cluster analysis of aspiration pressure signal waveforms using only two metrics. One metric captures a time-rate of change of pressure of the aspiration pressure measurement signal waveform, and the other metric captures an inflection characteristic of the aspiration pressure measurement signal waveform. The two metrics are used to establish detection thresholds (classification boundaries) based on training data, which includes pressure signal waveform samples representative of both normal aspirations and abnormal aspirations (of different types). In other embodiments, more than two metrics may be used. The training data may be unsupervised (i.e., not labeled), and the class boundaries for normal aspiration may be established based on K-means clustering employing a four-cluster classification based on only the two metrics. Alternatively, supervised classification techniques employing Support Vector Machines may also be used.

In other embodiments, early and accurate real-time detection or prediction of aspiration faults may be implemented via a software or firmware learning-based AI algorithm configured to perform probabilistic graphical modeling based on aspiration pressure measurement signal waveforms. In some of those embodiments, a Hidden Markov Model (HMM) may be used to predict aspiration faults based on examination of metrics derived from the aspiration pressure measurement signal waveforms. A 3-state left-to-right HMM architecture may be employed, and separate HMM models, one trained for “normal aspirations” and another trained for “abnormal aspirations” may be used. In some embodiments, N number of HMM models may be used, one trained for “normal aspirations” and each of the others trained for a particular type of “abnormal aspiration.” Each model may be trained using machine learning methods and labeled (supervised or unsupervised) sample training data. In the two-model embodiment, both HMMs may be run concurrently in real time on the measured aspiration pressure signal waveforms. The sequence emission probability over a contiguous sequence of pressure signal values is computed using both models. Classification of the aspiration as “normal” or “abnormal” may be carried out by comparing the relative sequence likelihood (PSEQUENCE NORMAL/PSEQUENCE ABNORMAL) or, alternatively, by comparing the sequence likelihood using the “normal” and “abnormal” HMM models against respective thresholds set for “normal” and “abnormal” aspiration.

In those embodiments where unlabeled sample training data having an arbitrary mix of normal and abnormal aspiration pressure waveforms is available, an unsupervised classification method such as K-means clustering may be used to automatically categorize the aspiration signal samples into a suitably chosen number of groups. Determination of which group may be considered normal aspirations may then be made by examining one or more samples from each group and relying on prior knowledge of how a normal aspiration waveform should appear.

Advantageously, both the cluster analysis and probabilistic graphical modeling embodiments of detecting or predicting aspiration faults can be implemented online and in real-time with low computational complexity (O(N)) as well as low memory requirements from commencement of an aspiration process and, thus, can be easily implemented in firmware or software. The training aspects of the cluster analysis (to determine fault thresholds) and the probabilistic graphical modeling can be performed offline. The trained transition and emission probabilities of the probabilistic graphical modeling can be stored in memory of a system controller, processor, or other like computer device to be used subsequently online to evaluate the fault state of each aspiration pressure measurement waveform in real-time at sampled time-instants.

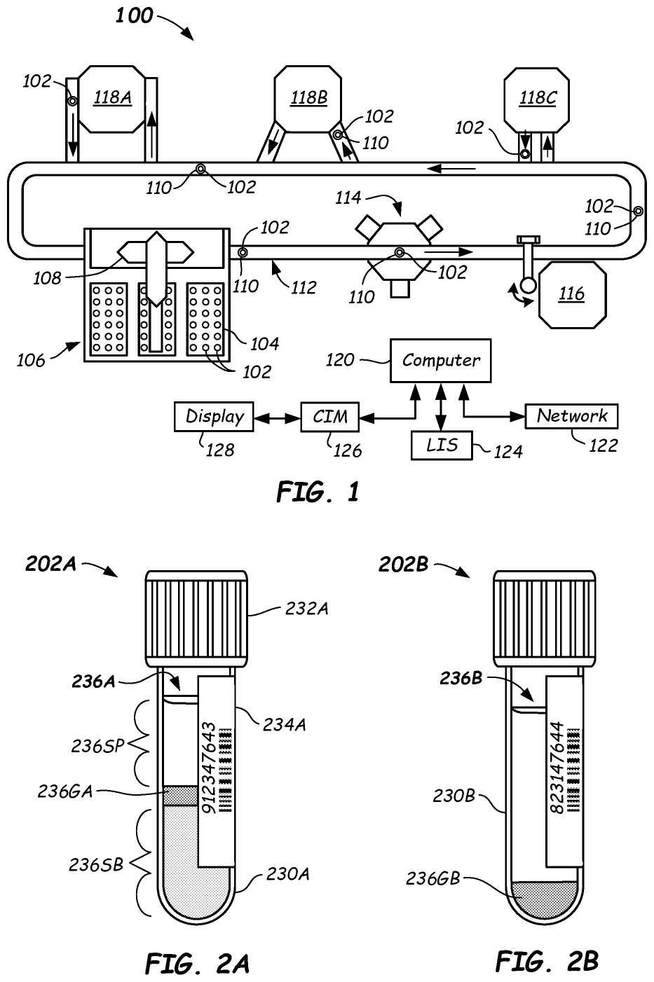

In accordance with one or more embodiments, methods and apparatus for early and accurate real-time detection or prediction of aspiration faults will be explained in greater detail below in connection with FIGS. 1-17.

FIG. 1 illustrates an automated diagnostic analysis system 100 according to one or more embodiments. Automated diagnostic analysis system 100 may be configured to automatically process and/or analyze biological samples contained in sample containers 102. Sample containers 102 may be received at system 100 in one or more racks 104 provided at a loading area 106. A robotic container handler 108 may be provided at loading area 106 to grasp a sample container 102 from one of racks 104 and load the sample container 102 into a container carrier 110 positioned on an automated track 112. Sample containers 102 may be transported throughout system 100 via automated track 112 to, e.g., a quality check station 114, an aspirating and dispensing station 116, and/or one or more analyzer stations 118A-118C.

Quality check station 114 may prescreen a biological sample for interferents or other undesirable characteristics to determine whether the sample is suitable for analysis. After successful prescreening, the biological liquid sample may be mixed with a liquid reagent, acid, base, or other solution at aspirating and dispensing station 116 to enable and/or facilitate analysis of the sample at one or more analyzer stations 118A-118C. Analyzer stations 118A-118C may analyze the sample for the presence, amount, or functional activity of a target entity (an analyte), such as, e.g., DNA or RNA. Analytes commonly tested for may include enzymes, substrates, electrolytes, specific proteins, abused drugs, and therapeutic drugs. More or less numbers of analyzer stations 118A-118C may be used in system 100, and system 100 may include other stations (not shown), such as centrifuge stations and/or de-capping stations.

Automated diagnostic analysis system 100 may also include a computer 120 or, alternatively, may be configured to communicate remotely with an external computer 120. Computer 120 may be, e.g., a system controller or the like, and may have a microprocessor-based central processing unit (CPU) and/or other suitable computer processor(s). Computer 120 may include suitable memory, software, electronics, and/or device drivers for operating and/or controlling the various components of system 100 (including quality check station 114, aspirating and dispensing station 116, and analyzer stations 118A-118C). For example, computer 120 may control movement of carriers 110 to and from loading area 106, about track 112, to and from quality check station 114, aspirating and dispensing station 116, and analyzer stations 118A-C, and to and from other stations and/or components of system 100. One or more of quality check station 114, aspirating and dispensing station 116, and analyzer stations 118A-C may be directly coupled to computer 120 or in communication with computer 120 through a network 122, such as a local area network (LAN), wide area network (WAN), or other suitable communication network, including wired and wireless networks. Computer 120 may be housed as part of system 100 or may be remote therefrom.

In some embodiments, computer 120 may be coupled to a laboratory information system (LIS) database 124. LIS database 124 may include, e.g., patient information, tests to be performed on a biological sample, the time and date the biological sample was obtained, medical facility information, and/or tracking and routing information. Other information may also be included.

Computer 120 may be coupled to a computer interface module (CIM) 126. CIM 126 and/or computer 120 may be coupled to a display 128, which may include a graphical user interface. CIM 126, in conjunction with display 128, enables a user to access a variety of control and status display screens and to input data into computer 120. These control and status display screens may display and enable control of some or all aspects of quality check station 114, aspirating and dispensing station 116, and analyzer stations 118A-C for prescreening, preparing, and analyzing biological samples in sample containers 102. CIM 126 may be used to facilitate interactions between a user and system 100. Display 128 may be used to display a menu including icons, scroll bars, boxes, and buttons through which a user (e.g., a system operator) may interface with system 100. The menu may include a number of functional elements programmed to display and/or operate functional aspects of system 100.

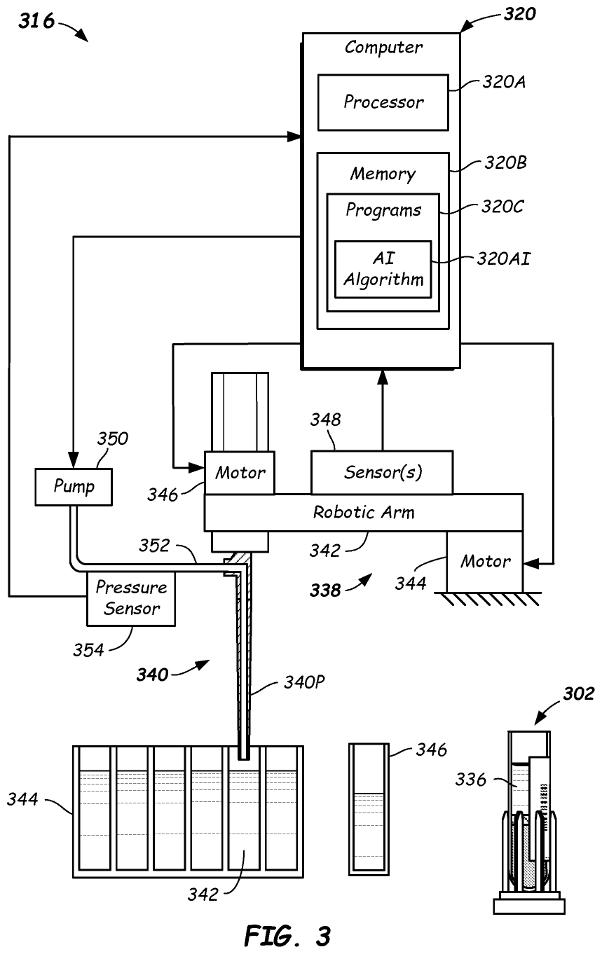

FIGS. 2A and 2B illustrate sample containers 202A and 202B, respectively, which are each representative of a sample container 102 of FIG. 1. Sample containers 202A and 202B may be any suitable liquid container, including transparent or translucent containers, such as blood collection tubes, test tubes, sample cups, cuvettes, or other containers capable of containing and allowing the biological samples therein to be prescreened, processed (e.g., aspirated), and analyzed. As shown in FIG. 2A, sample container 202A may include a tube 230A and a cap 232A. Tube 230A may include a label 234A thereon that may indicate patient, sample, and/or testing information in the form of a barcode, alphabetic characters, numeric characters, or combinations thereof. Tube 230A may contain therein a biological sample 236A, which may include a serum or plasma portion 236SP, a settled blood portion 236SB, and a gel separator 216GA located there between. As shown in FIG. 2B, sample container 202B, which may be structurally identical to sample container 202A, may contain therein a homogeneous biological sample 236B, wherein tube 230B has a gel bottom 236GB.

As described in more detail below, an improperly positioned probe that contacts either gel separator 236GA or gel bottom 236GB (e.g., red blood cells) during an aspiration process may result in an aspiration fault that can have detrimental consequences such as, e.g., faulty test results and/or system downtime.

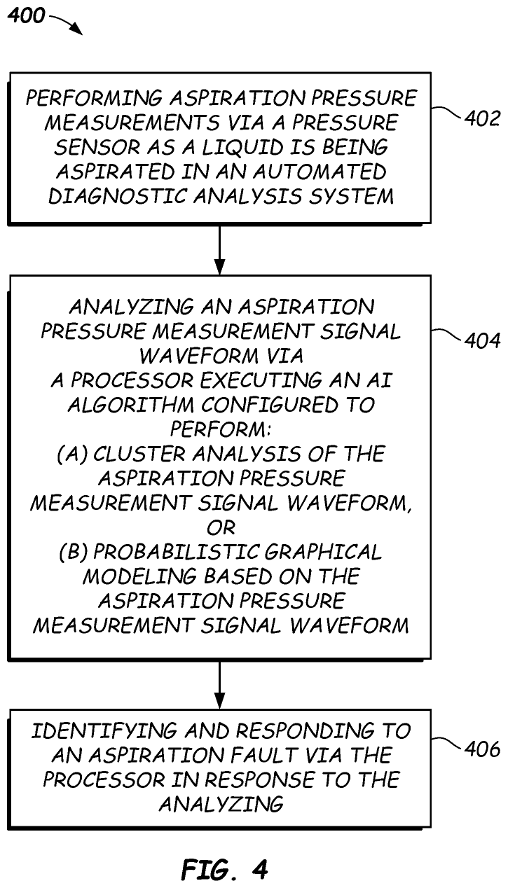

FIG. 3 illustrates an aspirating and dispensing apparatus 316 according to one or more embodiments. Aspirating and dispensing apparatus 316 may be part of, or representative of, aspirating and dispensing station 116 of automated diagnostic analysis system 100. Optionally, an aspirating and dispensing apparatus 316 may be part of or adjacent to one or more of the analyzer stations 118A-118C. Note that the methods and apparatus described herein for detecting or predicting an aspiration fault may be used with other embodiments of aspirating and dispensing apparatus.

Aspirating and dispensing apparatus 316 may aspirate and dispense biological samples (e.g., samples 236A and/or 236B), reagents, and the like into a reaction vessel to enable or facilitate analysis of the biological samples at one or more analyzer stations 118A-C. Aspirating and dispensing apparatus 316 may include a robot 338 configured to move a probe assembly 340 within an aspirating and dispensing station. Probe assembly 340 may include a probe 340P configured to aspirate, e.g., a reagent 342 from a reagent packet 344, as shown. Probe assembly 340 may also be configured to aspirate a biological sample 336 from a sample container 302 (after its cap is removed, as shown), which is positioned at aspirating and dispensing apparatus 316 via, e.g., automated track 112. Reagent 342, other reagents, and a portion of sample 336 may be dispensed into a reaction vessel, such as a cuvette 346, by probe 340P. In some embodiments, cuvette 346 may be configured to hold only a few microliters of liquid. Other portions of biological sample 336 may be dispensed into other cuvettes (not shown) along with other reagents or liquids by probe 340P.

Operation of some or all components of aspirating and dispensing apparatus 316 may be controlled by a computer 320. Computer 320 may include a processor 320A and a memory 320B. Memory 320B may have programs 320C stored therein that are executable on processor 320A. Programs 320C may include algorithms that control and/or monitor positioning of probe assembly 340 and aspiration and dispensing of liquids by probe assembly 340. Programs 320C may also include an artificial intelligence (AI) algorithm 320AI configured to detect or predict an aspiration fault as described further below. In some embodiments, computer 320 may be a separate computing/control device coupled to computer 120 (system controller). In other embodiments, the features and functions of computer 320 may be implemented in and performed by computer 120. Also, in some embodiments, the functions of probe assembly positioning and/or probe assembly aspiration/dispensing may be implemented in separate computing/control devices.

Robot 338 may include one or more robotic arms 342, a first motor 344, and a second motor 346 configured to move probe assembly 340 within, e.g., aspirating and dispensing station 116 of system 100. Robotic arm 342 may be coupled to probe assembly 340 and first motor 344. First motor 344 may be controlled by computer 320 to move robotic arm 342 and, consequently, probe assembly 340 to a position over a liquid container. Second motor 346 may be coupled to robotic arm 342 and probe assembly 340. Second motor 346 may also be controlled by computer 320 to move probe 340P in a vertical direction into and out of a liquid container for aspirating or dispensing a liquid therefrom or thereto. In some embodiments, robot 338 may also include one or more sensors 348, such as, e.g., current, vibration, and/or position sensors, coupled to computer 320 to provide feedback and/or to facilitate operation of robot 338.

Aspirating and dispensing apparatus 316 may also include a pump 350 mechanically coupled to a conduit 352 and controlled by computer 320. Pump 350 may generate a vacuum or negative pressure (e.g., aspiration pressure) in conduit 352 to aspirate liquids, and may generate a positive pressure (e.g., dispense pressure) in conduit 352 to dispense liquids.

Aspirating and dispensing apparatus 316 may further include a pressure sensor 354 configured to measure aspiration and dispensing pressure in conduit 352 and to accordingly generate pressure data. The pressure data may be received by computer 320 and may be used to control pump 350. An aspiration pressure measurement signal waveform (versus time) may be derived by computer 320 from the received pressure data and may be input to AI algorithm 320AI for detection or prediction of an aspiration fault in probe assembly 340 during an aspiration process. Aspiration pressure measurement signal waveforms derived from the received pressure data from pressure sensor 354 may also be used to train AI algorithm 320AI to detect or predict aspiration faults. Pressure sensor 354 may be located at any suitable location in the fluid path for sensing pressure.

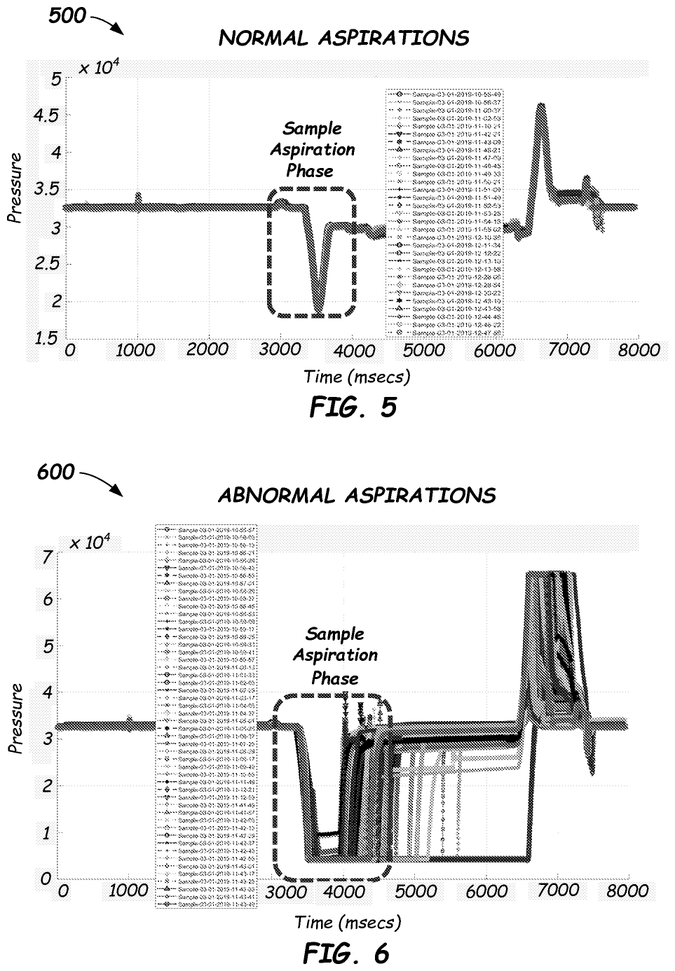

FIG. 4 illustrates a method 400 of detecting or predicting an aspiration fault in an automated diagnostic analysis system according to one or more embodiments. At process block 402, method 400 may begin by performing aspiration pressure measurements via a pressure sensor as a liquid is being aspirated in an automated diagnostic analysis system. For example, aspiration pressure measurements may be made by pressure sensor 354 of aspirating and dispensing apparatus 316 (of FIG. 3), which may be part of aspirating and dispensing station 116 of automated diagnostic analysis system 100 (of FIG. 1). Optionally, an aspirating and dispensing apparatus similar or identical to aspirating and dispensing apparatus 316 may integrated into or be located as part of the one or more analyzer stations 118A-118C.

At process block 404, method 400 may include analyzing an aspiration pressure measurement signal waveform via a processor executing an artificial intelligence (AI) algorithm configured to perform either (A) cluster analysis of the aspiration pressure measurement signal waveform, or (B) probabilistic graphical modeling based on the aspiration pressure measurement signal waveform. In some embodiments, the cluster analysis may include using only two metrics based on the aspiration pressure measurement signal waveform. In some embodiments, the probabilistic graphical modeling may implement two probabilistic graphical models concurrently executed on the aspiration pressure measurement signal waveform. In other embodiments, the cluster analysis may include more than two metrics based on the aspiration pressure measurement signal waveform. In still other embodiments, the probabilistic graphical modeling may implement more than two probabilistic graphical models (one pertaining to normal aspirations and each of the others pertaining to a different type of abnormal aspiration) concurrently executed on the aspiration pressure measurement signal waveform.

Analyzing an aspiration pressure measurement signal waveform to detect or predict an aspiration fault is based on distinguishable differences between characteristics exhibited by pressure measurement signal waveforms of normal aspirations and characteristics exhibited by pressure measurement signal waveforms of abnormal aspirations (representing fault conditions).

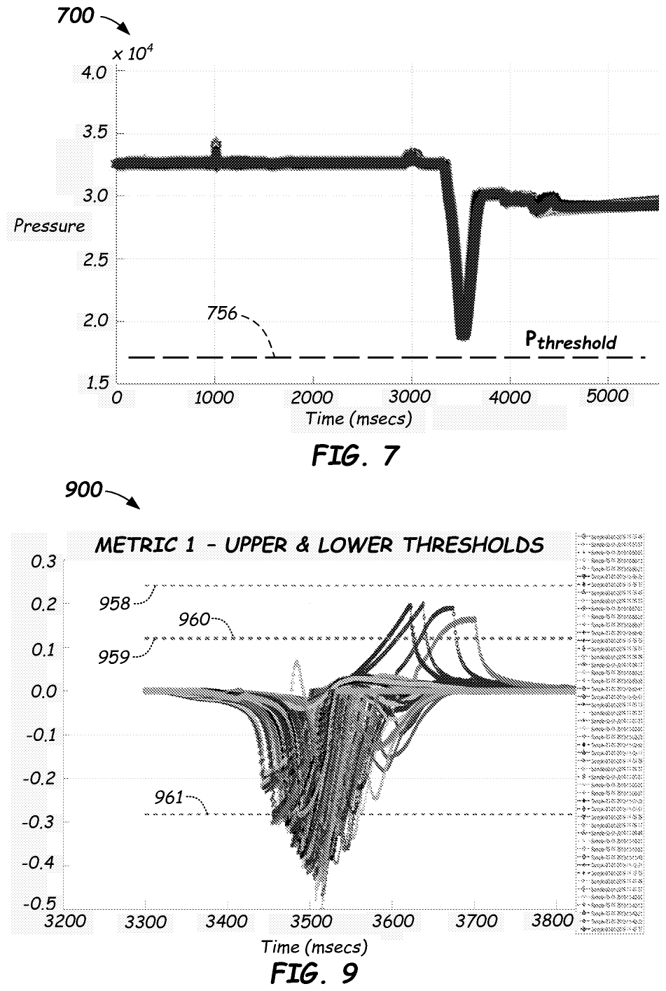

For example, FIG. 5 illustrates an aspiration pressure signal versus time graph 500 of approximately 30+ measured pressure signal waveforms (substantially superimposed on one another) of normal aspirations according to one or more embodiments. The normal aspirations may have been performed in an aspirating and dispensing apparatus such as, e.g., aspirating and dispensing apparatus 316 (of FIG. 3).

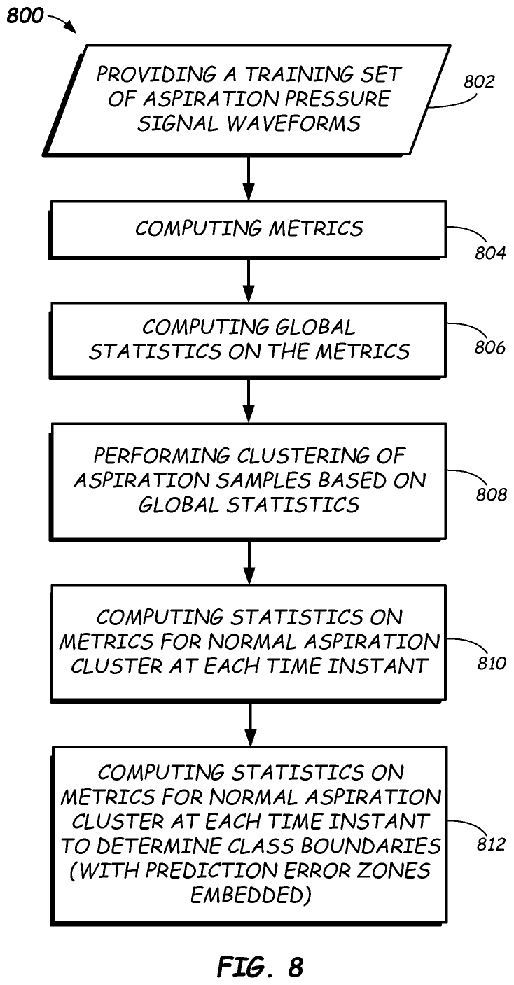

FIG. 6 illustrates an aspiration pressure signal versus time graph 600 of approximately 30+ pressure signal waveforms of abnormal aspirations according to one or more embodiments. The abnormal aspirations may have occurred in an aspirating and dispensing apparatus such as, e.g., aspirating and dispensing apparatus 316 (of FIG. 3).

The distinguishable characteristic differences between the signal waveforms of graph 500 and 600 can be detected in real-time during an aspiration process by a trained AI algorithm, such as, e.g., AI algorithm 320AI. AI algorithm 320AI, which is executable by processor 320A, may be implemented in any suitable form of artificial intelligence programming including, but not limited to, a neural network, including a convolutional neural network (CNNs), a deep learning network, a regenerative network, or another type of machine learning algorithm or model. Note, accordingly, that AI algorithm 320AI is not, e.g., a simple lookup table. Rather, AI algorithm 320AI may be trained to detect or predict one or more types of aspiration faults and is capable of improving (making more accurate determinations or predictions) without being explicitly programmed.

In some embodiments, detection of aspiration fault conditions by AI algorithm 320AI may be based on cluster analysis using only two metrics derived from an aspiration pressure measurement signal waveform during an aspiration process. The two metrics are used as predictors of aspiration faults. Detection thresholds (having classification boundaries or ranges) are based on the only two metrics, training data and, in some embodiments, K-means clustering. Other suitable clustering algorithms may be possible. The training data is representative of both normal aspirations and different types of abnormal aspirations. Temporally varying classification ranges are established based on statistical measures.

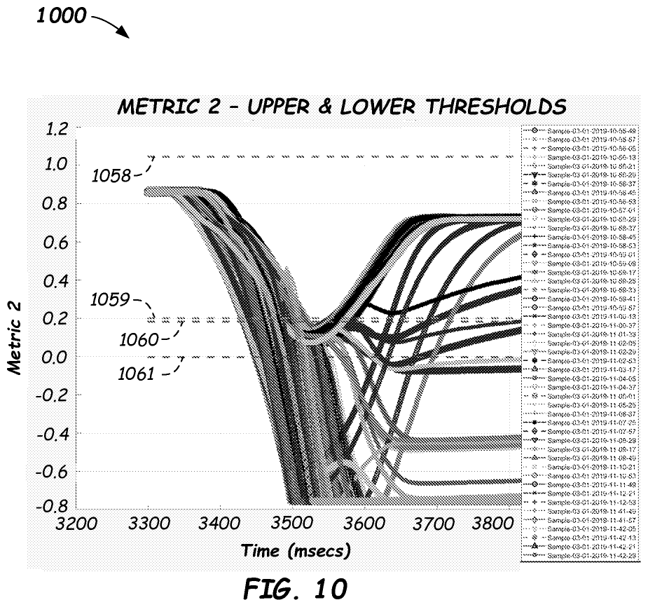

A first of the two metrics is:

$$Metric 1 = \frac{P ( t )}{{P}_{threshold}} \frac{\frac{\overline{dP ( t )}}{dt}}{max \{ ( P ( t ) - {P}_{threshold} ) , ε \}}$$

wherein:
P (t) is aspiration pressure measured at time t,
P (threshold) is a constant offset value selected to capture inflection of a pressure measurement signal waveform; FIG. 7 illustrates a graph 700 of a normal aspiration pressure signal waveform with a selected P (threshold) 756 according to one or more embodiments;

d̅P̅(̅t̅)̅/dt is a moving average of aspiration pressure slope; and

ε is a small number (e.g., 0.005) used to avoid singularity (division by zero in Metric 1 when P(t)=P(threshold).

The second of the two metrics is:

$$Metric 2 = \begin{matrix}( P ( t ) - {P}_{threshold} ) \\ {P}_{threshold}\end{matrix}$$

Metric 1 captures a time-rate of change of pressure, and Metric 2 captures the inflection characteristic of the aspiration pressure waveform. Metrics 1 and 2 have been found to be reliable predictors of impending or early-stage aspiration faults.

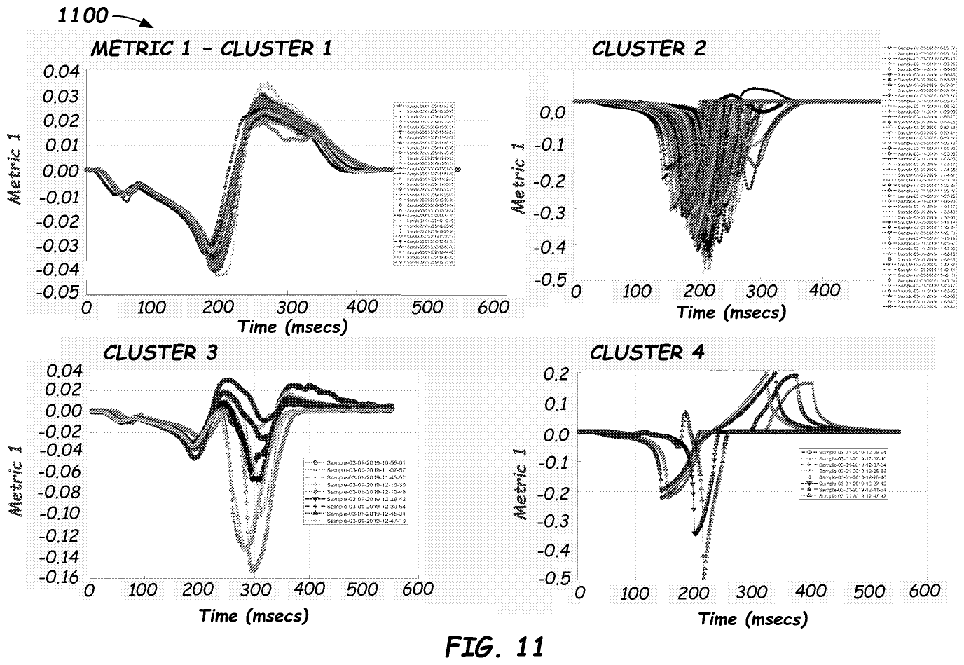

FIG. 8 illustrates a method 800 of training AI algorithm 320AI for clustering-based analysis of aspiration pressure signal waveforms according to one or more embodiments. Training of AI algorithm 320AI may be implemented offline. Determining an optimal number of clusters and tuning of parameters, such as P(threshold), moving-average filter parameters, ε, etc. can be performed through validation after training. Determining a suitable sample rate for real-time sampling of pressure measurements can be based on sensitivity to time-to-fault detection. For aspiration fault prediction robustness, multiple fault states over a set of time steps may be counted in some embodiments before identifying an aspiration as abnormal.

Method 800 may begin at input data block 802 where a training set of aspiration pressure signal waveforms are provided. At process block 804, Metric 1 and Metric 2 are computed for each sampled aspiration pressure measurement.

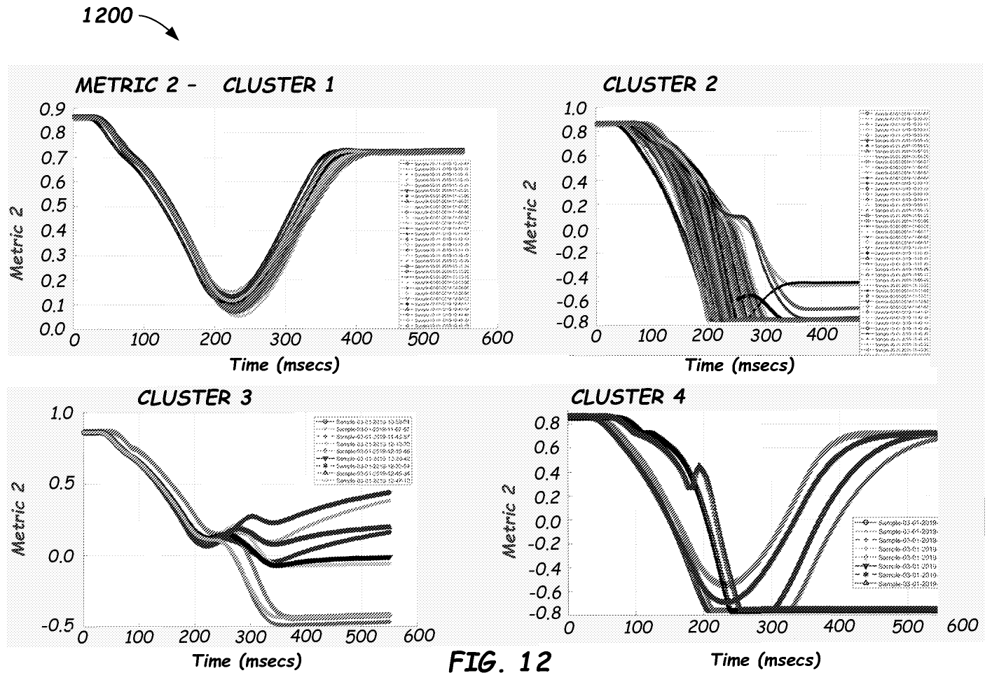

At process block 806, global statistics over a detection time window are computed for each of Metrics 1 and 2. Examples of detection time windows are shown in FIGS. 5 and 6 (see the outlined “Sample Aspiration Phase”). The global statistics include upper and lower thresholds based on global minimum and maximum values of the metric over the detection time window. For example, FIG. 9 illustrates a graph 900 of normal and abnormal aspiration pressure signal waveforms versus time, wherein upper thresholds 958 and 959 based on global minimum and maximum values of Metric 1 and lower thresholds 960 and 961 based on global minimum and maximum values of Metric 1 have been computed (note that lower threshold 960 just happens to be about the same as upper threshold 959) according to one or more embodiments. FIG. 10 illustrates a graph 1000 of normal and abnormal aspiration pressure signal waveforms versus time wherein upper thresholds 1058 and 1059 based on global minimum and maximum values of Metric 2 and lower thresholds 1060 and 1061 based on global minimum and maximum values of Metric 2 have been computed according to one or more embodiments.

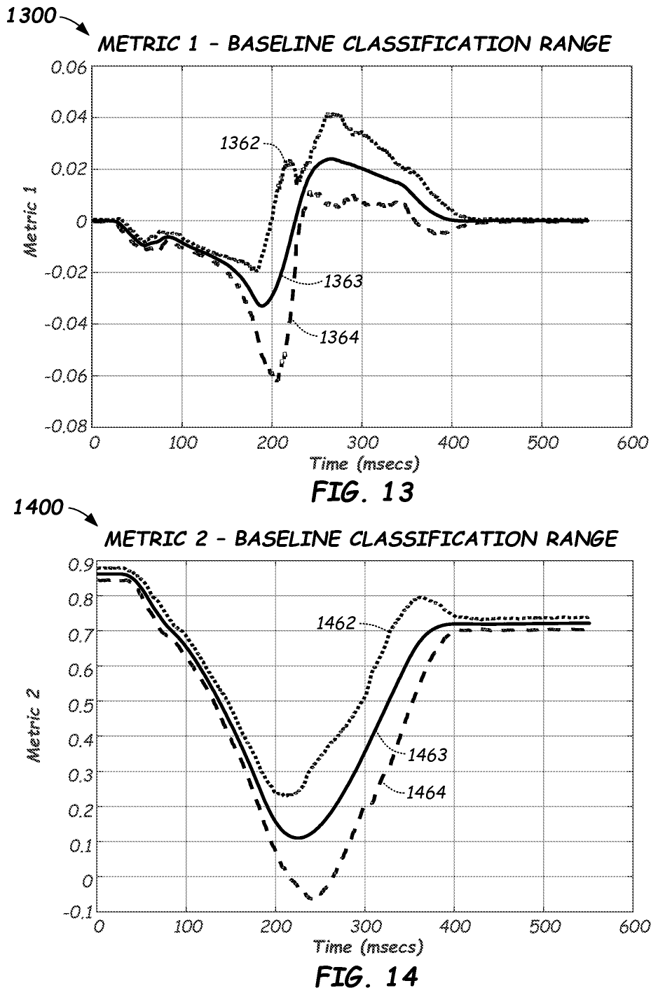

At block 808, clustering is performed on the sample aspirations based on the global statistics computed at process block 806 to identify the cluster corresponding to normal aspirations. FIG. 11 illustrates a four-cluster classification 1100 based on Metric 1 according to one or more embodiments, and FIG. 12 illustrates a four-cluster classification 1200 based on Metric 2 according to one or more embodiments. As shown in FIGS. 11 and 12, clustering based on global minimum and maximum values of Metric 1 and Metric 2 effectively isolates normal aspiration samples as shown in Cluster 1 from abnormal aspiration samples as shown in Clusters 2, 3, and 4.

At block 810, method 800 may include computing statistics (e.g., mean value and standard deviation) for each of Metrics 1 and 2 for the normal aspiration cluster (Cluster 1) at each time instant. These statistics may be used for classification of samples as normal or abnormal. Normal aspiration samples exhibit the lowest variability in mean value and standard deviation amongst all samples.

At block 812, method 800 may include computing normal aspiration statistics for each of Metrics 1 and 2 for Cluster 1 at each time instant to determine classification ranges. The following statistical procedure may be used to establish at each time sample the range for Metric 1 and Metric 2 that corresponds to the class (Cluster 1) of normal aspirations:

where

$${Metric}_{UpperLimit} ( t ) = {Metric}_{75 percentile} ( t ) + α {Metric}_{IQR}$$

$${Metric}_{LowerLimit} ( t ) = {Metric}_{25 percentile} ( t ) + α {Metric}_{IQR} ( t )$$

$${Metric}_{IQR} ( t ) = {Metric}_{75 percentile} ( t ) - {Metric}_{25 percentile} ( t )$$

$$( Note : t = time )$$

wherein α=1.5 or 3 (the optimal value of a can be tuned through validation after initial training), and
sampling time Ts=1/fs where fs is the sampling rate of pressure measurements during an aspiration process. A suitable sampling time may be, e.g., 1 msec. Other suitable sampling rates may be used.

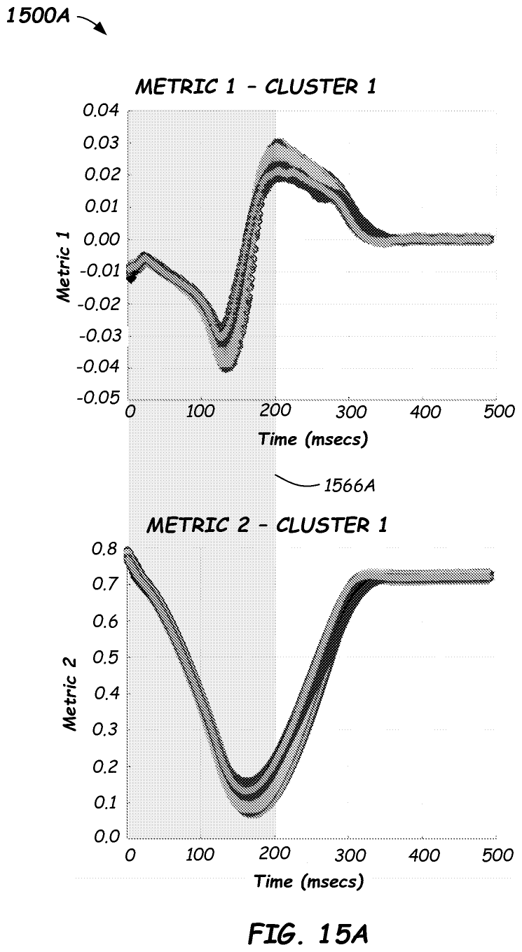

FIG. 13 illustrates a baseline classification zone or range 1300 for Metric 1, Cluster 1 based on the computations performed at process block 812 wherein α=3 according to one or more embodiments. Baseline classification range 1300 includes an upper limit curve 1362, a mean curve 1363, and a lower limit curve 1364.

FIG. 14 illustrates a baseline classification zone or range 1400 for Metric 2, Cluster 1 based on the computations performed at process block 812 wherein α=3 according to one or more embodiments. Baseline classification range 1400 includes an upper limit curve 1462, a mean curve 1463, and a lower limit curve 1464.

Note that baseline classification ranges 1300 and 1400 are determined and stored in non-parametric form as shown. In a first alternative embodiment, the baseline classification ranges may be parameterized via a global representation using a polynomial, B-spline, Auto-Regressive Moving-Average (ARMA) model, or other suitable basis function. In a second alternative embodiment, the aspiration phase may be subdivided into sub-phases (e.g., four) and the baseline classification ranges over each sub-phase may be parameterized individually via local representations using a polynomial, B-spline, ARMA model, or other suitable basis function. The parametric forms of the first and second alternative embodiments may require less memory but may incur additional computational costs in comparison to the non-parametric form.

Once established, baseline classification ranges 1300 and 1400 may be used in a cluster analysis of an aspiration pressure measurement signal waveform to detect/predict aspiration faults, as described below.

Returning to FIG. 4, method 400 may continue at process block 406 by identifying and responding to an aspiration fault via the processor in response to the cluster analysis performed at process block 404. An aspiration fault may be identified by determining for each sampled time instant of the aspiration pressure measurement signal waveform,

t=tₙ∈detection time window
whether:

$${Metric}_{i} ( t = {t}_{n} ) \leq {Metric}_{i , UpperLimit}$$

and

$${Metric}_{i} ( t = {t}_{n} ) \geq {Metric}_{i , LowerLimit}$$

for each of Metrics 1 and 2.

If the above conditions are not satisfied within the detection window, the aspiration may be identified as abnormal, and the aspiration process may be terminated and/or system procedures for an error state may be followed.

In other embodiments, instead of performing cluster analysis at process block 404 as described above, the analysis performed at process block 404 may alternatively include probabilistic graphical modeling based on the aspiration pressure measurement signal waveform, wherein two probabilistic graphical models are executed concurrently on the aspiration pressure measurement signal waveform. A Hidden Markov Model (HMM) may be used to model the dynamics of sample aspiration. A training data set of normal and abnormal aspiration samples are first identified either in a supervised manner (i.e., expert-based labeling of data) or in an unsupervised manner using machine-learning methods such as the K-means clustering described above. Because state transitions during sample aspiration are sequential such that a state transition may occur from the present state to an adjacent higher state value, a left-to-right HMM architecture may be used. Separate HMM models are trained, one for normal aspiration and another for abnormal aspiration, using the Expectation-Maximization (EM) algorithm. The “Expectation” step of the EM algorithm is applied in the form of the Baum-Welch (forward-backward) algorithm. Once training is completed, AI algorithm 320AI is configured to execute the normal and abnormal aspiration HMMs concurrently in real time on the measured aspiration pressure signal waveform. The sequence emission probability over a contiguous sequence of pressure signal values is computed using both HMMs. Classification of aspiration as normal or abnormal may be based on comparing the relative sequence likelihood:

PSEQUENCE, NORMAL/PSEQUENCE, ABNORMAL

or, alternatively, by comparing the sequence likelihood using the normal and abnormal HMMs against respective thresholds set for normal and abnormal aspiration. Training may be performed in an offline mode using training data sets for normal and abnormal aspiration. Once trained, the HMM models may be implemented online in firmware or software DML (Definitive Media Library) for aspiration fault detection/prediction in real time.

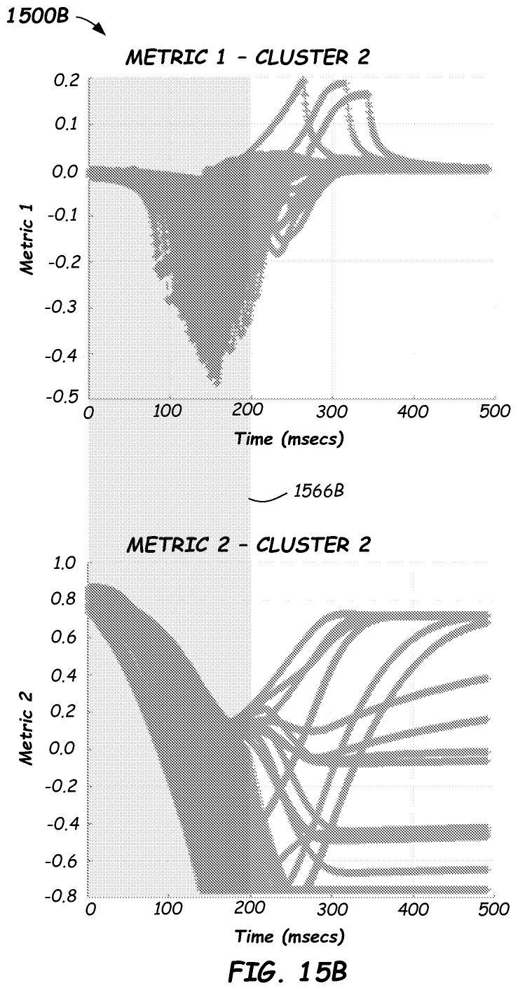

FIGS. 15A and 15B illustrate a two-cluster per metric classification 1500A, 1500B according to one or more embodiments, with the first cluster for each metric shown in FIG. 15A and the second cluster for each metric shown in FIG. 15B. Training of the normal and abnormal HMMs includes the following: (1) calculate Metric 1 and Metric 2 for each of Cluster 1 (normal aspirations) and Cluster 2 (abnormal aspirations within a pre-defined detection time window which, in some embodiments, may be detection time windows 1566A and 1566B, each of which may be 200 msec (other detection time windows may be used); (2) compute mean vectors of the metrics for the normal aspiration samples (Cluster 1) and subtract the computed mean vectors from mean vectors for each aspiration sample in the training set of samples; and (3) define the number of outputs/emissions—create discrete, quantized (integer value) range set of emissions by uniformly dividing the min-max range of the metric residues (from step (2)).

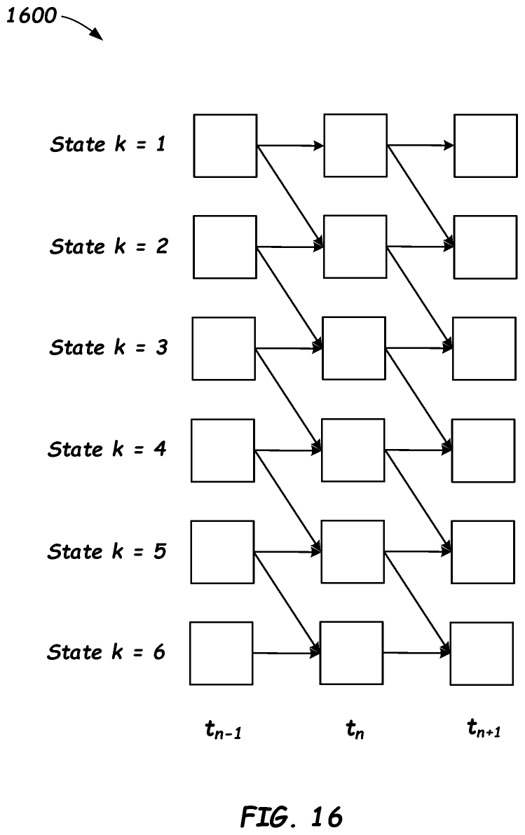

In some embodiments, detection or prediction of an aspiration fault may be performed by HMMs each having a left-to-right architecture 1600 as shown in FIG. 16 with six states k=1-6, constrained state transitions, twelve emission states, and a 15 time-step sequence.

In alternative embodiments, instead of executing HMMs over the entire detection time window of the aspiration process, the detection time window may be subdivided into sub-phases (e.g., four) wherein, for each sub-phase, separate HMM models for normal and abnormal aspiration may be trained and then executed on the measured aspiration pressures to detect/predict aspiration faults. By subdividing the detection time window into sub-phases, each of the HMMs may be reduced in complexity and/or size, thus reducing overall computational costs.

Returning to FIG. 4, method 400 may continue at process block 406 by identifying and responding to an aspiration fault via the processor in response to the probabilistic graphical modeling performed at process block 404. An aspiration fault may be identified by executing concurrently two HMMs (one trained for normal aspiration and the other trained for abnormal aspiration). In some embodiments, sequence likelihood first and second thresholds may be applied to each sampled time instant of the aspiration pressure measurement signal waveform to identify normal aspirations as follows:

PSEQUENCE, NORMAL>first threshold;

and

PSEQUENCE, ABNORMAL<second threshold;
wherein, in some embodiments, the first threshold may be 0.90 and the second threshold may be 0.50 (other suitable values for the first and second thresholds may be used).

The sequence likelihood is computed based on a composite probability of an observation sequence (length=15) conditioned on the corresponding known state sequence.

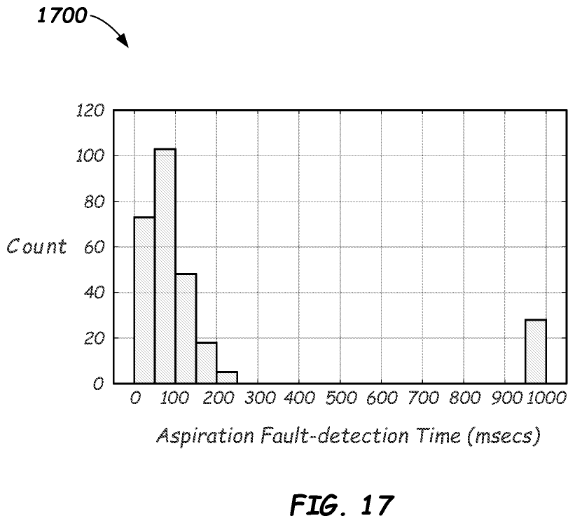

Advantageously, both the cluster analysis and the probabilistic graphical modeling as described herein detected and/or predicted aspiration faults within the first 100 msec of the commencement of an aspiration process (see, e.g., FIG. 17, which illustrates a histogram 1700 of detected aspiration faults among a data set of aspiration samples according to one or more embodiments). This early real-time aspiration fault detection or prediction may allow an aspiration process to be timely terminated and/or a suitable error state procedure to be implemented so as to advantageously avoid or minimize any possible downstream consequences of a faulty aspiration, such as, e.g., instrument downtime and/or erroneous analysis results.

Moreover, both the cluster analysis and the probabilistic graphical modeling have been found to advantageously perform efficient and accurate binary classification of sample aspirations as normal or abnormal in real-time. Both embodiments have low computational complexity (O(N)) and low memory requirements during online execution and, thus, can be easily implemented in firmware or software. Although both embodiments may incur higher computational cost during a training phase of AI algorithm 320AI (of FIG. 3), the training phase may be performed offline.

Note that the methods and apparatus described herein are not limited to any particular types of aspiration faults. For example, in addition to short volume and gel or undesirable material pickup aspiration faults, other faults caused by, e.g., inaccurate titration by the aspiration pump, software-related errors during titration, impaired flow conditions in the fluidics manifold upstream of the probe, and/or electrical noise and/or environmental effects adversely affecting titration may also be detected/predicted, provided that a sufficient number of sample aspiration pressure waveform samples (i.e., training data) exist for the particular type(s) of aspiration faults to be detected/predicted. The methods and apparatus described herein may then be applied to identify distinct metric profiles pertaining to each type of aspiration fault. Accordingly, the type and number of metrics used to detect/predict aspiration faults may be based on a particular aspiration profile of the particular aspiration fault to be detected/predicted. New metrics can be derived for any new aspiration profile. Similarly, the number of cluster classifications chosen for analysis depends on the number of expected categories of fault conditions and/or types, as well as availability of training data and the ability of the clustering analysis to categorize within an acceptable level of accuracy the different aspiration fault states existing in the training data. Thus, for example, the four-cluster classification described above may be reduced to a three-cluster classification if, e.g., a higher level of false negatives is acceptable. Thus, the methods and apparatus described herein are not limited to any particular type or number of metrics and/or clusters for detecting/predicting aspiration faults.

While this disclosure is susceptible to various modifications and alternative forms, specific method and apparatus embodiments have been shown by way of example in the drawings and are described in detail herein. It should be understood, however, that the particular methods and apparatus disclosed herein are not intended to limit the disclosure or the following claims.

What is claimed is:

1. A method of detecting or predicting an aspiration fault in an automated diagnostic analysis system, the method comprising:
performing aspiration pressure measurements via a pressure sensor as a liquid is being aspirated in the automated diagnostic analysis system;
analyzing an aspiration pressure measurement signal waveform via a processor executing an artificial intelligence (AI) algorithm configured to perform:
cluster analysis of the aspiration pressure measurement signal waveform, or
probabilistic graphical modeling based on the aspiration pressure measurement signal waveform; and
identifying and responding to an aspiration fault via the processor in response to the analyzing.

2. The method of claim 1, wherein the cluster analysis is based on unsupervised training data, or the probabilistic graphical modeling is based on supervised or unsupervised training data.

3. The method of claim 1, wherein the cluster analysis is based on labeled training data using supervised learning algorithms to establish thresholds with classification ranges.

4. The method of claim 1 wherein the cluster analysis comprises using only two metrics based on the aspiration pressure measurement signal waveform, or the probabilistic graphical modeling comprises two probabilistic graphical models concurrently executed on the aspiration pressure measurement signal waveform.

5. The method of claim 4, wherein the cluster analysis comprises K-means clustering employing a four-cluster classification based on the only two metrics.

6. The method of claim 4, wherein a first of the only two metrics captures a time-rate of change of pressure of the aspiration pressure measurement signal waveform that includes a moving average of aspiration pressure slope, and a second of the only two metrics captures an inflection characteristic of the aspiration pressure measurement signal waveform.

7. The method of claim 4 wherein a first of the two probabilistic graphical models is trained with normal aspiration data and a second of the two probabilistic graphical models is trained with abnormal aspiration data.

8. The method of claim 7 wherein an aspiration fault is determined based on a comparison of an output from the first probabilistic graphical model and an output from the second probabilistic graphical model.

9. The method of claim 1 wherein the probabilistic graphical modeling comprises a left-to-right Hidden Markov Model (HMM) architecture.

10. The method of claim 9, wherein the left-to-right HMM architecture comprises:
six states;
12 emission states; and
a 15 time-step sequence.

11. The method of claim 1 wherein the identifying and responding further comprises identifying and responding to an aspiration fault via the processor within 100 msec of commencement of the liquid being aspirated.

12. The method of claim 1 wherein the aspiration fault is a gel or undesirable material pickup or a short-volume aspiration.

13. An automated aspirating and dispensing apparatus, comprising:
a robotic arm;
a probe coupled to the robotic arm;
a pump coupled to the probe;
a pressure sensor configured to perform aspiration pressure measurements as a liquid is being aspirated via the probe; and
a processor configured to execute an artificial intelligence (AI) algorithm to detect or predict and respond to an aspiration fault during an aspiration process, the AI algorithm configured to analyze an aspiration pressure measurement signal waveform derived from the pressure sensor using cluster analysis or probabilistic graphical modeling.

14. The automated aspirating and dispensing apparatus of claim 13, wherein the cluster analysis comprises using only two metrics based on the aspiration pressure measurement signal waveform, or the probabilistic graphical modeling comprises two probabilistic graphical models concurrently executed on the aspiration pressure measurement signal waveform.

15. The automated aspirating and dispensing apparatus of claim 14, wherein the cluster analysis comprises K-means clustering employing a four-cluster classification based on the only two metrics.

16. The automated aspirating and dispensing apparatus of claim 14, wherein:
a first of the only two metrics captures a time-rate of change of pressure of the aspiration pressure measurement signal waveform; and
a second of the only two metrics captures an inflection characteristic of the aspiration pressure measurement signal waveform; or
a first of the two probabilistic graphical models is trained with normal aspiration data; and
a second of the two probabilistic graphical models is trained with abnormal aspiration data.

17. The automated aspirating and dispensing apparatus of claim 13, wherein the cluster analysis employs a plurality of cluster classifications wherein one of the plurality of cluster classifications represents normal aspiration data and others of the plurality of cluster classifications each represent a different type of abnormal aspiration data.

18. The automated aspirating and dispensing apparatus of claim 13, wherein the probabilistic graphical modeling comprises a plurality of probabilistic graphical models concurrently executed on the aspiration pressure measurement signal waveform, wherein one of the plurality of probabilistic graphical models is trained with normal aspiration data and others of the plurality of probabilistic graphical models are each trained with a different type of abnormal aspiration data.

19. The automated aspirating and dispensing apparatus of claim 13, wherein the probabilistic graphical modeling comprises a left-to-right Hidden Markov Model (HMM) architecture.

20. The automated aspirating and dispensing apparatus of claim 19 wherein the left-to-right HMM architecture comprises:
six states;
12 emission states; and
a 15 time-step sequence.

21. The automated aspirating and dispensing apparatus of claim 13, wherein the processor is configured via execution of the AI algorithm to identify and respond to an aspiration fault within 100 msec of commencement of a liquid being aspirated during the aspiration process.

22. An automated diagnostic analysis system, comprising:
the automated aspirating and dispensing apparatus of claim 13;
one or more analyzer stations for analyzing a biological sample; and
an automated track for transporting sample containers and reaction vessels to and from the automated aspirating and dispensing apparatus and the one or more analyzer stations.

23. A non-transitory computer-readable storage medium, comprising an artificial intelligence (AI) algorithm configured to detect or predict an aspiration fault based on analysis of an aspiration pressure measurement signal waveform using cluster analysis of the aspiration pressure measurement signal waveform or using probabilistic graphical modeling based on the aspiration pressure measurement signal waveform.
